(19) United States
(12) Patent Application Publication
(10) Pub. No.: US 2009/0176179 A1
(43) Pub. Date: Jul. 9, 2009

(54) METHOD FOR SINTERING STEEL

(76) Inventors: Rolf Andersson, Stockholm (SE); Soren Wiberg, Ekero (SE); Christoph Laumen, Munich (DE)

Correspondence Address: The BOC Group, Inc., 575 MOUNTAIN AVENUE, MURRAY HILL, NJ, 07974-2082, US

(21) Appl. No.: 12/349,194

(22) Filed: Jan. 6, 2009

(30) Foreign Application Priority Data
Jan. 8, 2008 (EP) 08000243.9

(51) Int. Cl. F27B 21/08

(52) U.S. Cl. 432/13

(57) ABSTRACT

The invention relates to a method for sintering in a furnace atmosphere wherein said furnace atmosphere is a hydrogen-free atmosphere comprising nitrogen and carbon monoxide.

The invention relates to method for sintering in a furnace with a controlled atmosphere.

Sintering is defined as the thermal treatment of a powder or compact at a temperature below the melting point of the main constituent, for the purpose of increasing its strength by bonding together of the particles. During sintering atomic diffusion takes place and the powder particles are welded together.

The sintering operation is normally to be carried out under a controlled protective atmosphere in order to prevent oxidation and to promote the reduction of surface oxides, as well as to control the carbon content to a desired level throughout the whole sintered specimen.

The carbon potential of a furnace atmosphere is equal to the carbon content that pure iron would have in equilibrium with the atmosphere. The carbon activity (aC) of a furnace atmosphere is the carbon content a metal or alloy would have compared to the reference, graphite, defined as being equal to aC=1. Both the carbon activity and the carbon activity in sintering processes affects the final properties of the sintered parts in many ways.

Carbon will react with oxides forming gases such as carbon dioxide and thereby decarburize the components. Carbon will also react with the surrounding atmosphere forming gases such as CH₄, if hydrogen is available. Further, if hydrogen is available oxygen and hydrogen will react and form water which is very de-carburising. If hydrogen is not available oxygen will form carbon dioxide which is also de-carburising. The resulting change in carbon content in the material to be sintered will change the phase transformation temperatures and the resulting microstructures.

Especially critical is the carbon content in the surface of the specimen since a de-carburization there leads to less resistance to fatigue failures. This is an important issue in order to expand the sintering business to the production of high strength sintered parts, for example for motor components or transmission parts.

In practice the most used sintering atmospheres today contain about 90% nitrogen and 10% hydrogen, sometimes with small additions of CH₄. However, such an atmosphere is not in thermodynamic equilibrium at the conditions in the sintering furnace. This makes it very difficult to control the carbon flux in and out of the sintered material. In practice, the carbon control is achieved by keeping the water level to a minimum.

Beside the described synthetic nitrogen-hydrogen atmosphere, today the sintering atmosphere is often produced by the reaction of a hydrocarbon gas with a limited amount of air. Since this reaction is endo-thermic, external heat has to be supplied, and the resulting atmosphere is called endogas. If made from natural gas the endogas may contain up to 40 vol % of hydrogen, some carbon monoxide (ca 20 vol %), carbon dioxide and water (ca 0.3-1 vol %) with the remainder being nitrogen.

The role of hydrogen in the composition of the furnace atmosphere is to assist the reduction of oxides on the powder grain surface of the material to be sintered. But often carbon in the form of fine graphite powder is added to the sintering material. It has been found that the added carbon also reacts with the surface oxides, thus reducing the importance of the atmosphere components, especially of hydrogen, as a reduction promoter. However, in the end of the sintering process when all added carbon is already dissolved into the matrix, the role of the furnace atmosphere becomes more important.

Thus it is an object of the invention to develop a controlled furnace atmosphere which prevents de-carburization of the sintered material, in particular in the end of the sintering phase.

This object is achieved by a method for sintering in a controlled furnace atmosphere, wherein said furnace atmosphere is a hydrogen-free atmosphere comprising nitrogen and carbon monoxide.

According to the invention a furnace atmosphere is used which is essentially free of hydrogen and which comprises nitrogen and carbon monoxide. The concentration of carbon monoxide in nitrogen could be between 0.1 and 99 vol %. The proposed sintering atmosphere has no or only low driving force for de-carburization.

When adding CO to a conventional N₂—H₂-process atmosphere the carbon transfer takes place via the adsorption of CO molecules on the surface of the workpiece and its dissociation into C and O:

CO→CO_{(ad)}→C_{(ad)}+O_{(ad)}

and by the desorption of the adsorbed oxygen atoms by the H₂ molecules

O_{(ad)}+H₂→H₂O

thereby forming water vapour and creating new empty sites for the CO-adsorption. The formed water vapour is considered to be very de-carburizing.

The invention uses the fact that by taking away the hydrogen the adsorbed CO molecules dissociate into C_{(ad)}+O_{(ad)} as described above, but with the difference that the oxygen atoms cannot react with hydrogen but only react along the reaction

O_{(ad)}+C→CO

which is a far more sluggish and slow reaction than

O_{(ad)}+H₂→H₂O.

The result is a much less de-carburising atmosphere than the conventional atmosphere containing hydrogen.

In a preferred embodiment the inventive sintering atmosphere comprises between 80 vol % and 99.9 vol % nitrogen, more preferred between 95 vol % and 99.5 vol % nitrogen; and between 0.2 vol-% and 20 vol % carbon monoxide, more preferred between 0.2 vol % and 5 vol % carbon monoxide.

Preferably, said furnace atmosphere comprises a carbon containing enrichment gas. It is especially preferred to use acetylene, propane andlor methane as enrichment gas. By adding a carbon containing gas to the furnace atmosphere the carbon activity can be positively affected.

The aim of an enrichment gas is to adjust the carbon potential/activity to a pre-set value. The enrichment gases react with the oxidising species like water, carbon dioxide and free oxygen according to the examples with propane and methane below:

C₃H₈+3CO₂→6CO+4H₂

C₃H₈+3H₂O→3CO+7H₂

or

CH₄+CO₂→2CO+2H₂

CH₄+H₂O→CO+3H₂

Preferably, after the sintering process the sintered material is rapidly cooled, especially by gas cooling. This is preferably achieved by quenching the sintered parts by means of a cold protective gas. Thereby cooling rates of up to 50° C./sec are achievable. It has been found that a homogeneous martensitic microstructure is achieved which is good enough to put the sintered part into final operation without the need for case-hardening after sintering. The combination of sintering and hardening in one step reduces the production costs, especially of low alloy steel parts.

As already mentioned, the inventive furnace atmosphere is in thermodynamic equilibrium. Thus, it is possible to implement a process control using an external heated oxygen probe or a gas analyser measuring carbon dioxide in combination with measurements of the carbon monoxide level and the process temperature.

The invention is preferably used for sintering of metals of any kind, in particular metallic material comprising one or more of iron, steel, aluminium, copper, brass, bronze or hard metals. Further alloying elements such as chromium, manganese, silicon, nickel, molybdenum, cobalt or tungsten may be added to or included in the material to be sintered.

The invention provides a solution to the most restricting factor in sintering technology, namely the carbon neutral sintering. By using the inventive method it is possible to manufacture parts by sintering which are today produced in solid steel with costly subsequent efforts in mechanical operations, such as machining or turning. Parts sintered according to the invention show only very small dimensional tolerances so that there is no need for reworking.

The invention has several advantages compared to the prior art. The inventive atmosphere is neutral with respect to carburization, that is, undesired de-carburization as well as carburization are avoided. Metal oxides, in particular surface metal oxides, are reduced and oxidation is prevented.

The inventive atmosphere may be advantageously produced by one of the following methods:
Removal of hydrogen from endogas:
   In order to create the inventive atmosphere hydrogen is removed from the endogas. This is preferably achieved by using adsorption techniques, in particular a PSA process (pressure swing adsorption).
Removal of hydrogen from syngas:
   Syngas or synthesis gas, is the name given to gases of varying composition that are generated in coal gasification and some types of waste-to-energy gasification facilities. Syngas consists primarily of carbon monoxide and hydrogen. By removing the hydrogen from the syngas an inventive atmosphere is created which has a high carbon monoxide concentration.
Removal of hydrogen from cracked methanol since cracked methanol could be regarded as a syngas with the composition of 33% CO and 67% H₂.
Production of carbon monoxide with added air over a heated bed of doped graphite:
   Air or nitrogen with a quality containing residual oxygen levels up to 3% is used and the contained oxygen is caused to react to carbon monoxide inside the furnace over a graphite or coal bed or in an external coal filled reactor.
Production of carbon monoxide by dissociating formic acid injected into a heated reactor filled with sulphuric acid or phosphoric acid. The formed carbon monoxide is then dried from water and scrubbed to reach neutral pH-value.

As an example, a preferred atmosphere composition would be 3% CO, 96.8% N₂ and 0.2% C₃H₈

The inventive sintering method preferably works at temperatures between 1120° C. and 1250° C.

1. Method for sintering in a furnace atmosphere, comprising said furnace atmosphere being hydrogen-free and comprising nitrogen and carbon monoxide.

2. Method according to claim 1, wherein said furnace atmosphere comprises a carbon containing enrichment gas.

3. Method according to claim 2, wherein said enrichment gas is selected from acetylene, propane and methane.

4. Method according to claim 1, wherein said furnace atmosphere is produced by removing hydrogen from syngas, from endogas or from cracked methanol.

5. Method according to claim 1 wherein said furnace atmosphere is produced by reacting nitrogen comprising less than 10% oxygen, over graphite.

6. Method according to claim 1, comprising injecting formic acid into a heated reactor filled with sulphuric acid or phosphoric acid; and dissociating said formic acid for producing carbon monoxide.

7. Method according to claim 1, comprising controlling the sintering by means of an heated external oxygen probe or a carbon dioxide gas analyser in combination with measuring carbon monoxide and furnace temperature.

8. Method according to claim 1, wherein said furnace atmosphere comprises between 1% and 5% CO, between 90% and 99% N₂ and between 0.05% and 1% hydrocarbon gas.
